(19) United States
(12) Patent Application Publication
(10) Pub. No.: US 2002/0158916 A1
(43) Pub. Date: Oct. 31, 2002

(54) Graphical e-commerce shopping terminal system and method

(75) Inventors: Carl Phillip Gusler, Austin, TX (US); Rick Allen Hamilton II, Charlottesville, VA (US)

Correspondence Address: Robert H. Frantz, P.O.Box 23324, Oklahoma City, OK, 73123-2334, US

(73) Assignee: International Business Machines Corporation, Armonk, NY

(21) Appl. No.: 09/843,065

(22) Filed: Apr. 26, 2001

(51) Int. Cl. G09G 5/00; G06F 17/60

(52) U.S. Cl. 345/850; 705/27

(57) ABSTRACT

A communications terminal which provides an enhanced sensory experience coupled to an virtual shopping mall with an apparent geographical coupling between cyberstores within the virtual mall such that cyberstore proprietors may control shopping environment factors such as visual images and sounds. Through presentations of images and sounds relevant and coordinated to a shopper's “position” within the cybermall, a shopper may view images and hear sounds simulating a real shopping mall experience using a personal digital assistant, web-enabled wireless telephone, or similar mobile device having a graphical display. As a shopper “moves” through the cybermall, graphical images of mall hallways are presented in logical sequence showing store fronts and facades, with selectable areas in the images defining entry points to enter the stores. As stores are entered, specific images of store interiors are provided, allowing each store to control and generate an environment within their own store. Throughout the shopping experience, relevant audible sounds are provided to the shopper, such as general mall hallway sounds while in the mall, and store-specific background sounds and music while in a selected store.

### CROSS-REFERENCE TO RELATED APPLICATIONS (CLAIMING BENEFIT UNDER 35 U.S.C. 120)

This application is related to U.S. application Ser. No. ______ (to be amended when serial number is assigned), docket number AUS920010173US1, filed on ______, 2001, by Rick Hamilton, II, et al, which is commonly assigned with this application.

### FEDERALLY SPONSORED RESEARCH AND DEVELOPMENT STATEMENT

This invention was not developed in conjunction with any Federally sponsored contract.

### MICROFICHE APPENDIX

Not applicable.

### INCORPORATION BY REFERENCE

The related U.S. application Ser. No. ______ (to be amended when serial number is assigned), docket number AUS920010173US1, filed on ______ 2001, by Rick Hamilton, II, et al, is hereby incorporated by reference in its entirety, including drawings.

### BACKGROUND OF THE INVENTION

1. Field of the Invention

This invention relates to the technologies of online and off-line shopping and e-commerce, and especially to the graphical technologies for representing commerce facilities, organization, and navigation of shopping centers using communications terminal devices such as personal digital assistants, handheld personal computers, Internet appliances, and web-enabled telephones.

2. Description of the Related Art

In today's competitive commercial and retail environment, owners and employees of physical “bricks and mortar” stores often view web-based commerce as competition. For example, a local bookstore owner recognizes such online proprietors as Amazon.com as a direct competitor. In some instances, retail franchise owners may view the online web site of the same franchise name, albeit operated by the master franchiser, as even more direct competition because there is a high level of overlap in inventory as well as identical name brand recognition.

Many online shopping “malls”, or “cybermalls”, have been developed as web-based purchasing has become culturally acceptable to consumers and as online purchasing security concerns have been addressed. However, these online shopping malls are typically little more than a group of hyperlinked web sites or portions of web sites, accessible through a common “home” page. Turning to FIG. 1, the well-known arrangement of web browser computers (1) and web servers (5) interconnected by the Internet or World Wide Web (3) or intranets (6). Typically, the browser computer (1) comprises a personal computer running a web browser software such as Netscape's Navigator, using a protocol such as Transmission Control Protocol/Internet Protocol (TCP/IP) running over a dial-up modem connect, digital subscriber line (DSL), cable modem, or the like. The web server (5) typically consists of a web platform, such as IBM's Websphere product, and communicates to browser computers using Hyper Text Transfer Protocol (HTTP) by transmitting web objects including Hyper Text Markup Language Documents (HTML), graphic images (GIF, JPEG, etc.), audio and video clips (AVI, WAV, etc.), JAVA applets, and other common types of content objects. Hyperlinking for automatically addressing these types of web objects is well known in the art, and is prevalent throughout today's web environment.

Cybermalls exist currently as a loose collection of store web sites, for example, a grouping of online shoe stores accessible by a single hop or “click” from a common access point. Some cybermalls are collections of store sites offering products with geographical relationships, such as products made only in New England, Idaho, or Hawaii. Many bricks-and-mortar malls provide a variety of store types, including some specialty stores, some department stores, and meeting places such as food courts and restaurants, as do many cybermalls.

During the 1980's when automatic teller machines (ATM) became widely available for bank customers, banks found that their ability to distinguish themselves from competitors was subsequently reduced as their clients visited their physical facilities less and less often, favoring to make most transactions with a convenient ATM. For example, a first bank may have established a very respectable, reliable image, with bank lobbies furnished in luxurious furniture, marble, and artwork. Clients who frequent this bank's lobby are given an impression that the bank is well established, and higher fees may be more acceptable. Another bank, perhaps a credit union, may adopt a more Spartan image, with more practical and cost effective furniture, such as “cube” furniture, in order to project an image of efficiency and cost effectiveness.

However, as bank clients began to conduct the vast majority of their banking transactions with an ATM, they visited the bank's actual facilities very seldom and in some cases never. So, the clients view of the bank became that of the ATM terminal not the bank's lobby or building. Since there is very little difference between the appearances of ATM terminals, banks subsequently found it very difficult to distinguish their desired image from their competitors images.

So has become the problem for retailers in malls and online. While in physical form in a mall, a retailer may use choices of lighting, display materials and designs, background sounds and music, and store facade design to generate an image, it is very difficult to present the same image in a distinguishing manner through a web browser. As such, some online-only retailers, such as Amazon com, have been able to quickly establish an image comparable and competitive with bricks-and-mortar retailers such as Borders and Barne's and Noble.

Presently, online marketplaces are frequently set up in one of two fundamental ways. Firstly, consider that stores and malls may be presented in their entirety as a single domain, with possible divisions between departments (e.g., men's wear, households, etc), as shown in FIG. 2. A mall home page (21) may contain a group of hyperlinks to various store home pages (23, 24, and 25), which in turn provide hyperlinks to department pages (26,27,28,29,200, and 201). The tree structure of these sites are well known and are not unlike the tree structures of other, non-retail web sites.

Secondly, online malls are often organized so that visiting one “mall-front” shows lists of stores of possible interest to the visitor, and often provide search facilities (36) based on store names or product categories, as shown in FIG. 3. In this example, the web browser framer (31) which is displayed on a portion (30) of a web browsing device's display provides BACK and FORWARD navigation buttons (33, 34), and a location or address entry (32). Some online malls, as well as some online convention halls (wherein virtual convention “booths” are presented), provide a map-like view (37) of the virtual “layout” of the mall. This usually does not correspond to a real mall design, but is presented to enhance the browser's shopping experience. The cursor or pointer (35) may be used by the browser to select an icon, button, or store on the map. Again, similar to the first method described, these stores may either be organized as separate domains or accessible through the same domain. Again, too, it is evident that this organization of information is not unlike organization of information on other types of non-retail web sites. Thus, the “look and feel” of visiting these types of online malls is not much different that that of visiting other types of web sites, and certainly does not parallel the full sensory experience of visiting a real, bricks-and-mortar mall. Current online malls have little commonality or coherence to result in return visits, known as “stickiness”, when compared to real shopping malls.

Many of the carefully selected factors in real stores are lost in the online shopping experience. A mall operator may group certain types of stores based on a crossover business potential, such as placing a linen store, a bath products store, and a women's dress shop in close proximity to each other to target female shoppers. Within “cyberstores” themselves, other factors have not been translated well to the online experience, such as the use of background music and sounds to set a mood or environment to complement a store's or department's product lines.

The related application disclosed a new method and system through which a mall shopper of an online shopping mall may be presented with an multimedia experience similar to a real shopping experience, including the ability to graphically navigate a map of a shopping mall, view images of mall structures such as store facades and hallways, enter stores and navigate hallways through selection of hot spots in images, and navigate within stores while being presented with images of the store interior spaces and products. During all of these processes, relevant sounds, such as background noise in the open spaces and background music within a store, are presented to the shopper, as well, in order to complete the pseudo-real shopping experience.

However, the system and method described were disclosed in terms of online web browsing, preferably as a Java applet executed by a web browser with real-time delivery of image, sound and data files as the shopper navigates an online mall. There is a growing class of Internet appliances, web-enabled telephones, web-enabled personal digital assistants and handheld computers which are capable of communications with a network server over a communications network, but do not have the processing bandwidth or memory of full-capability web browser computers.

The comparative resource limitations of such mobile devices will likely continue because as memory and processor bandwidth become more affordable, each mobile device's resources will be increased accordingly, but so will each computer's resources. As such, there will likely be a considerable disparity between the resources available on a desktop or laptop computer when compared to the resources and capabilities of a mobile device.

Therefore, there is a need in the art for a system and method which provides a more realistic shopping experience for virtual shopping malls and complexes using a web-enabled mobile device. Additionally, there is a need in the art for the new system and method to support online and off-line shopping modes as online “connection time” is typically a premium resource to be minimized by any application of the device.

### BRIEF DESCRIPTION OF THE DRAWINGS

The following detailed description when taken in conjunction with the figures presented herein provide a complete disclosure of the invention.

FIG. 1 illustrates the well-known arrangement of web browser devices and web servers.

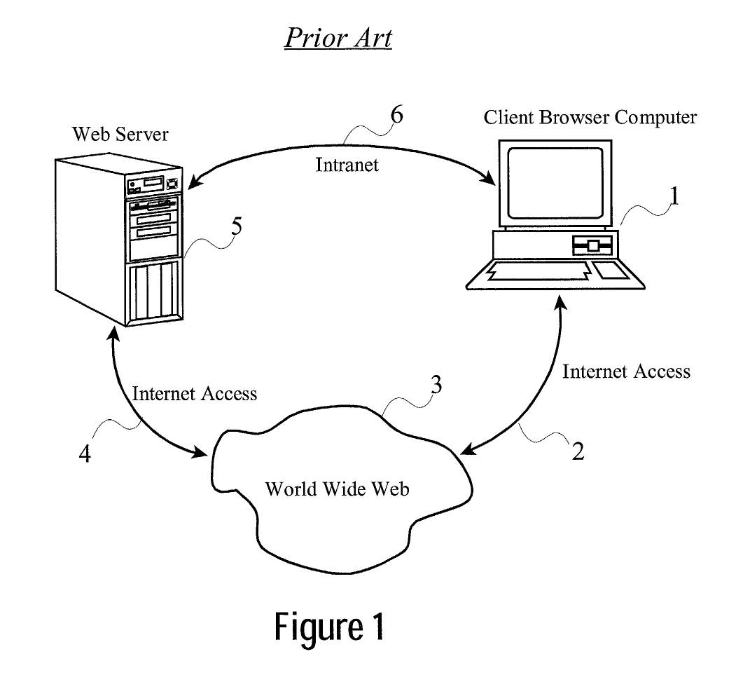

FIG. 2 shows the typical tree-like structure or organization of online mall information.

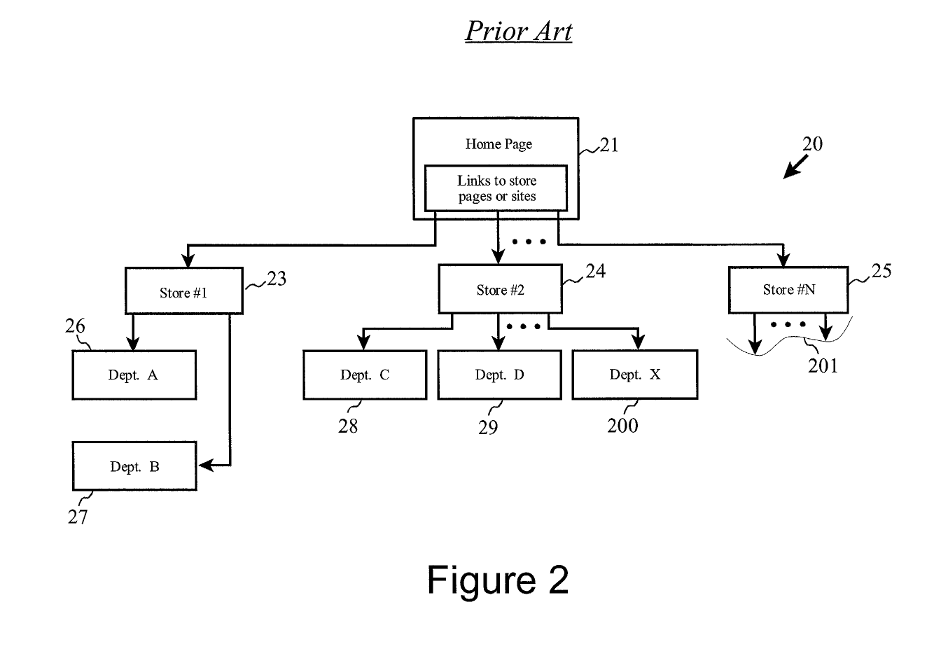

FIG. 3 shows a typical online mall front page with a “map” of a virtual mall.

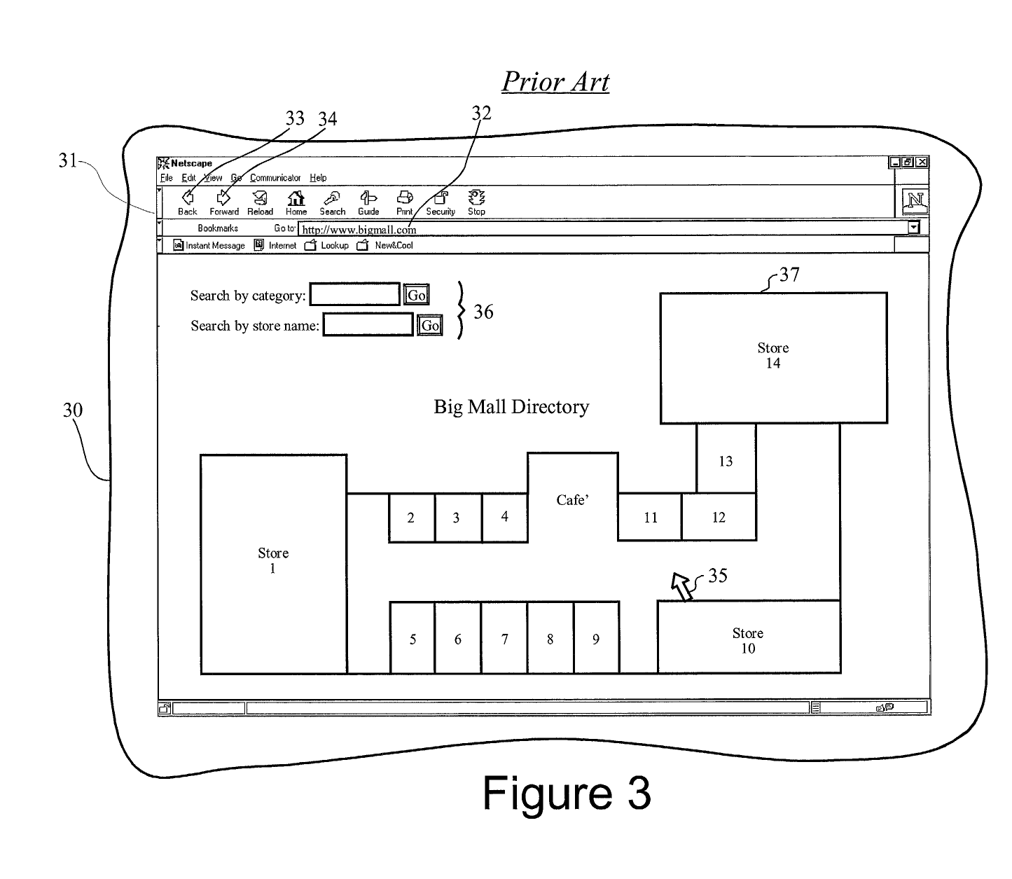

FIG. 4 discloses the enhanced view of an online mall front page including a “you are here” indicator, and an icon to select the full sensory presentation of the mall shopping visit.

FIG. 5 shows an example presentation of a visual image from a particular vantage point or position within a cybermall in which multiple adjacent store fronts may been seen.

FIG. 6 sets forth the common arrangement of components of mobile devices such as PDA's, web enabled telephones, and handheld personal computers.

FIG. 7 illustrates the logical process performed by the invention.

### SUMMARY OF THE INVENTION

The present invention provides an enhanced sensory experience coupled to an virtual shopping mall which creates an apparent geographical coupling between cyberstores within the virtual mall, and which enables store proprietors to control shopping environment factors.

Using presentation of visual images and audible sounds relevant and coordinated to a shopper's “position” within the cybermall, a shopper may view images and hear sounds simulating a real shopping mall experience using a personal digital assistant, web-enabled wireless telephone, or similar mobile device having a graphical display.

As a shopper “moves” through the cybermall, graphical images of mall hallways are presented in logical sequence showing store fronts and facades, with selectable areas in the images defining entry points to enter the stores. As stores are entered, specific images of store interiors are provided, allowing each store to control and generate an environment within their own store. During the entire experience, relevant audible sounds are provided to the shopper such as general mall hallway sounds while in the mall, and store-specific background sounds and music while in a selected store.

The navigation, image, and audio facilities are provided by an application program loaded to a mobile device to enable the invention to be utilized with a wide variety of mobile devices and platforms. According to the preferred embodiment, images, audio, and data are downloaded and stored to minimize online connection time, and to facilitate off-line shopping.

### DETAILED DESCRIPTION OF THE INVENTION

The invention is provided preferably as an application program executable by a mobile device such as a personal digital assistant (PDA), web-enabled wireless telephone, handheld personal computer, or other Internet appliance.

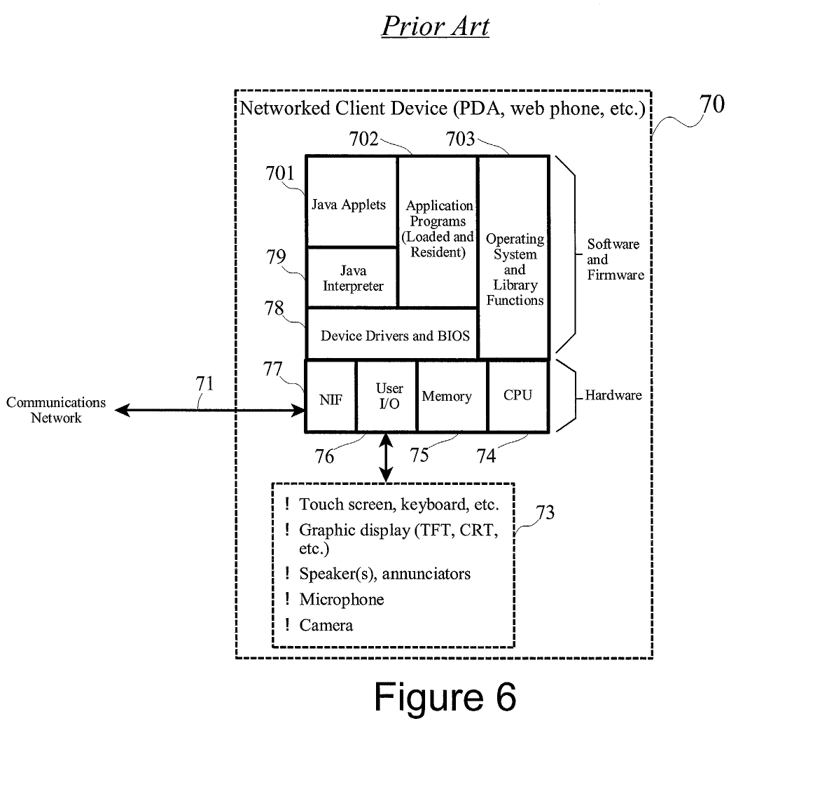

Turning to FIG. 6, the generalized arrangement of such web-enabled mobile devices (70) is shown. The mobile device includes a CPU or microprocessorr (74), system memory (75) such as RAM and ROM, and a set of user interface devices (73) including a graphical display such as a color LCD panel. Other user interface devices commonly provided on this mobile devices include a touch-screen input, keyboard, pointing device, speakers or annunciators, microphone and camera.

The mobile device (70) is also provided with an operating system and set of library functions (703). The library functions may include a communications protocol stack such as TCP/IP, electronic mail functions such as a Simple Mail Transfer Protocol (SMTP) suite, and user interface functions such as handwriting recognizors. A suitable communciations network interface (77) to a communications network (71) is also preferrably provided in the mobile device, such as a dial-up modem, wireless modem, or InfraRed communications port (IRDa). Device drivers (78) allow abstraction between the library functions and the application programs (702).

These mobile devices are typically provided with a suite of resident or pre-loaded applications such as phone books, “to do” list managers, calendars, email browsers, etc. Other applications may be installed by downloading from a communications network server, or by installation from a memory device such as a FlashROM card, PCMCIA card, etc.

This general representation of mobile devices is representative of a wide variety of available products, from PDA's such as the Palm Pilot [TM], to web-enabled wireless telephones such as Motorola's StarTac[TM], to Internet appliances such as Cidco's MailStation[TM]. According to the preferred embodiment, the invention is realized in combination with a Palm model m505 PDA, which has a high-resolution 16-bit color LCD display, PalmOS [TM] operating system, infrared communications port, 8 MB of system memory, touchscreen input, and a FlashROM card port. Palm provides two options for interfacing to a communications network through connection to a mobile telephone, such as a PCS handset, or using an integral wireless modem. By equipping the PDA with either communication option, application programs may access the Internet and send/receive electronic mail using PalmOS library functions.

While the Palm PDA is selected as the platform of the preferred embodiment due to its open operating system and superior display characteristics, it will be recognized by those skilled in the art that realization of the invention on any other suitable platform may be made without departing from the spirit and scope of the invention.

The remainder of the disclosure given herein is made in terms of the method implemented in an application program targeted for the mobile device. According to the preferred embodiment, the method set forth is embodied in a PalmOS-compatible application program using the Palm software developers kit (SDK). Several suitable C and C++ compilers are available for use in compiling the application.

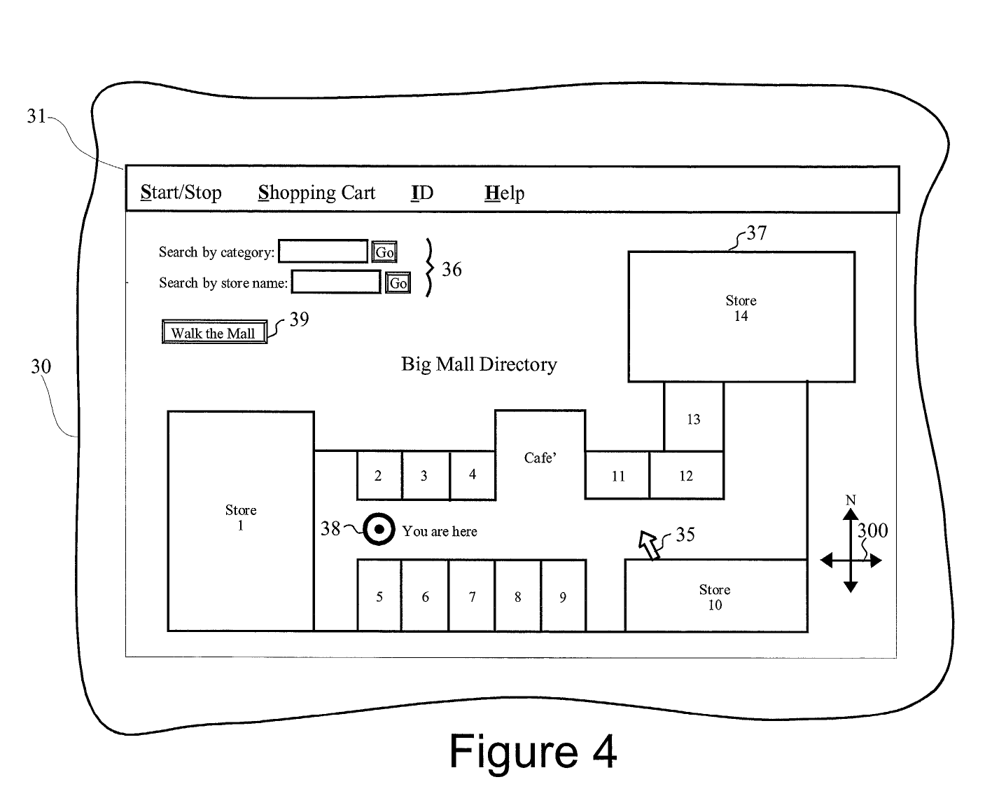

Turning to FIG. 4, the enhanced mall front page (31) provided by the invention is shown This graphic image is displayed on a portion (30) of the mobile device's graphical display. In this view, the mall map (37) is enhanced to include a shopper position indicator (38), and preferably a geographic orientation icon (300).

Based upon a current coordinate or position of the “shopper” within the mall, maintained by the application program, the shopper may see his or her position within the mall floor plan. Preferably, the shopper may “click and drag” the position indicator (38) using the pointer or touchscreen stylus (37) to move to another position within the mall, or go directly to another position within the mall floor plan by double clicking anywhere in the floor plan.

Further, the mall front page is enhanced to include a “walk the mall” button or icon (39), which invokes the multimedia experience of the invention. This could alternatively be invoked by the double clicking action previously described.

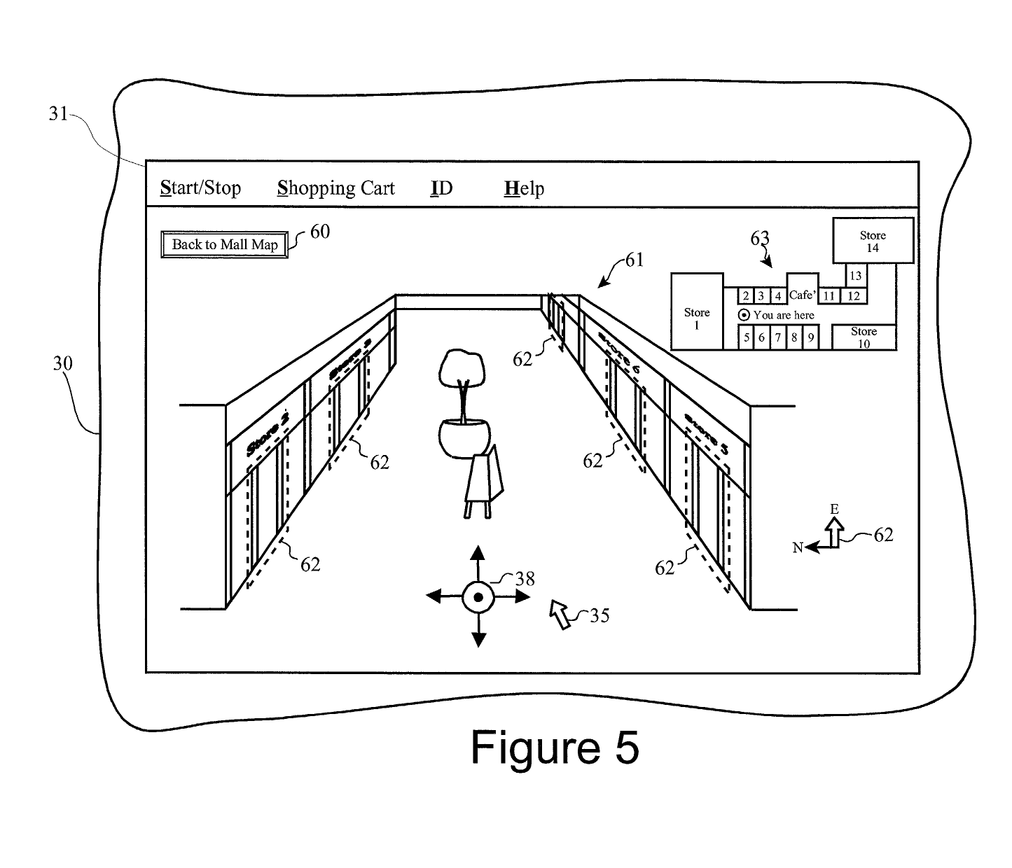

FIG. 5 shows an example presentation of the visual image from a given position within a mall floor plan, including store facades, and the position indicator (38). The position indicator (38) may be provided with arrows or pointers showing possible directions of movement. A view indicator (62) also may be provided to allow the shopper greater understanding of which direction he or she is “facing” in the cybermall, as well as a miniaturized mall floor plan (63) for more efficient navigation of the cybermall. A button or icon (60) to return to the mall front page is also preferably provided.

From this view, the user or shopper may click and drag the position indicator (38) using the pointer (35), or a combination of keys, to move through the mall. As the shopper's position is changed, the presented image is updated accordingly.

The image may be a photograph, such as images taken from within an actual mall, in the form of well-known graphic web objects (GIF, JPEG, etc.), or a simulation of an real view of the mall using vector and/or bitmap graphics similar to those used in gaming technologies.

The images are provided with “hot spots” (62) or regions within the images that, when selected, activate a hyperlink to other images or other web pages. Such hot spots may be place over and around store doors, windows, and hallway turns. For example, to enter a particular store, the user could click on the door for the store. Or, to take a direct view into the display window of a store, the user could click on the image of the window. Methods to provide hot spots in graphic images with hyperlinks are well known in HTML and other common web object types.

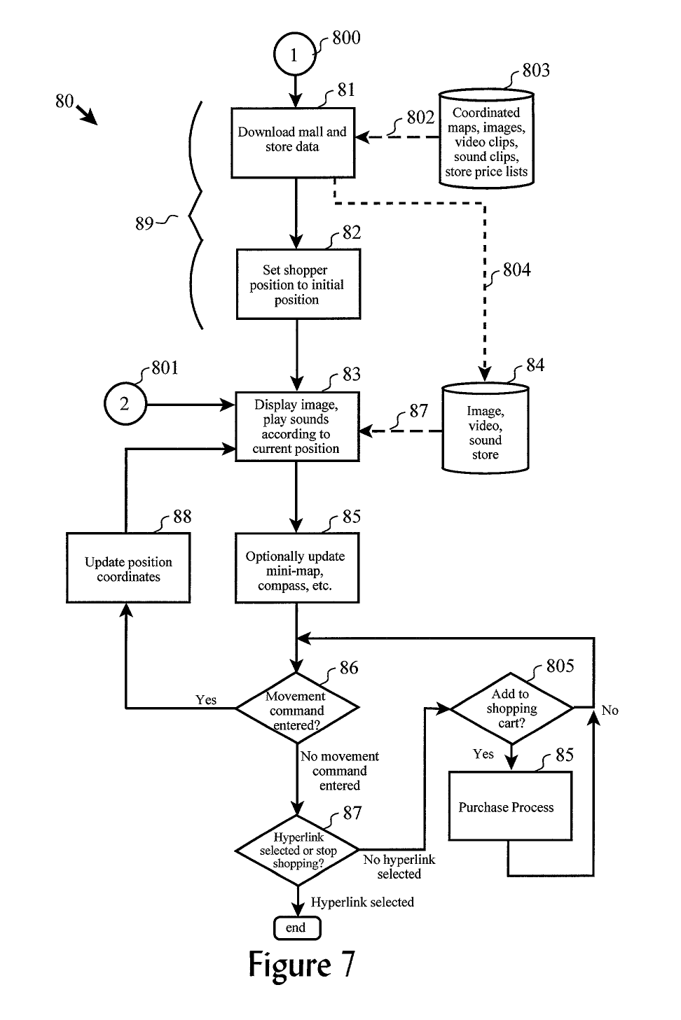

Turning to FIG. 7, the logical process performed by the application program is shown. Upon initialization (89) of the mall in the mobile device, the mall and store data is downloaded (802) via a communications network from a server (803). This may be a download over the Internet in the form of File Transfer Protocol (FTP), email attachement, or other suitable file and data download protocol. The data may include multiple graphic image files and audio recording files, each indexed to positions and coordinates in one or more mall map files. In an enhanced embodiment of the invention, store price lists, product descriptions and product images may also be downloaded to enable off-line shopping and ordering. All of these data items are stored (804) in the mobile device's memory (84) for use by the application program, whether the device is connected online or is off-line during the subsequent shopping session.

As described in the related application, the mall floor plan or map is divided into discrete coordinates (81), and the shopper's position is set to an initial position (82) to initialize the shopping session.

During the shopping session, images are displayed and sounds are played (83) by the application program corresponding to the current position of the shopper in the cybermall floor plan. In the preferred embodiment, this is accomplished by querying the mobile device's memory for relevant image and sound web objects including JPEG and GIF image files and “wave” audio files. These data objects are retrieved (87) from memory (84), and displayed and played on the mobile device's user interfaces. In an enhanced embodiment, these data objects may include streaming video and/or video clips.

Further according to the preferred embodiment the mini-map display and compass or other directional indicator are updated (85) to reflect the current position within the mall.

Each time a movement command is entered by the shopper, such as pressing an arrow key or dragging the position indicator, the movement command is received (86) by the application program, which then updates the position coordinates of the shopper (88), and subsequently the images and sounds are changed (83) to correspond with the new position. The coordinate system used may be 2-dimensional, such as for a “one story” mall, or multi-dimensional to represent a multi-story mall.

This process continues as the shopper “moves” through the mall, each move causing new images and/or sounds to be retrieved and played to the web browser user, until a hot spot or hyperlink is selected (87), at which time the application program is repointed to the linked address. This may link to a normal web page, such as an ordering or shopping cart page, or may link to another virtual shopping experience application program section, such as entering a store through the “door” on the store's image. In this latter case, a new map, perhaps a detailed map of the interior of a store, may be provided along with presentation of images and sounds relevant to the shopper's position within the store.

Also according to the preferred embodiment, each time a link is selected to another web page or to another virtual shopping session, a record is created of the shopper's last position in the current session, such as by storing a value in the mobile device's memory (84). This allows the application program to remember the “exit point” from the current session, in order to allow the shopper to return from the next shopping visit or web page. In this case, when returning to a previous session, the process re-starts from point 2 (801) as shown in FIG. 7, wherein the current position is retrieved from the previous position memory such as by retrieving a cookie from the browser. For example, if a shopper selects a hyperlink to a order entry web page, he may complete the order and then return to the same position in the mall where he left. Or, he may enter a store map through a hot spot on the image of the front of the store, shop throughout a “sub-map” of the interior of the store, and return back “through the front door” into the hallway of the mall by returning to his last position in the previous shopping session.

This allows the invention to be used to “nest” visits to an infinite level, so that malls may be divided in to linked sections, such as upstairs and downstairs, stores can be linked to malls, and departments may be linked to stores. This modularization of the representation of the mall in the preferred embodiment allows the different mall sections, stores and departments to be developed and maintained as separate groups of web objects interrelated by the link definitions. It also lends itself very well to object oriented programming techniques for implementation.

This position memorization and local storage of data objects allows the shopper to navigate the mall while connected online or while off-line. Off-line shopping capabilities allow the user to minimize the connection time consumed by the mobile device, which is usually a premium resource on a mobile device, measured in minutes of connection or units of data transferred.

A further enhancement of the invention allows for the downloaded data objects to include store price lists, product descriptions, and product images. This may allow the user to add a particular item to a “shopping cart” (805) and to complete a purchasing process such as filling out an order form (85). This order form may then be transmitted during an online period by email, secure hypertext transfer (HTTPs), or other data transfer protocol such as common gateway interface (CGI), using the mobile device's resident application programs and library functions. These price lists and product descriptions may be provided with expiration dates such that old or stale data would not be used to place new orders.

Using these coordinated, relevant presentations of information (sights, sounds, and maps), the user is given a sense of physical relationship of the stores within the mall, and a sense of the store environment while shopping in the store. For example, while in the “hallways” of an upscale cybermall, the user may hear classical or jazz music and see images of designer flooring, wall treatments, and planters. When entering a nature and science products store, the sounds change to new age music, and the images change to nature and science products displayed on shelves and counter tops. In another mall, perhaps an outlet mall, background audible announcements about specials in various stores may be heard while in the hallway, and when entering a clothing store specializing in outdoor products, nature sounds may be heard.

While specific details of the preferred embodiment and alternate embodiments have been disclosed herein, it will be recognized by those skilled in the art that many substitutions, variations and alternate embodiments may be adopted without departing from the spirit and scope of the invention. For example, other programming techniques, device hardware platforms, and data object types may be adopted as suitable and as they become available. The scope of this invention should be limited only by the language of the following claims.

What is claimed is:

1. A method of presenting information regarding products, suppliers and offerors to users in a virtual shopping mall on a communications terminal, said communications terminal having a user graphical display, a user input, and a memory, said method comprising:
storing in said memory a set of mall data objects, said mall data objects comprising a graphical map of a virtual shopping mall, said map having a coordinate system associated with positions within the shopping mall, and a plurality of multimedia data objects indexed to said coordinate system;
assigning a customer an initial position having a set of coordinates within the shopping mall;
presenting at least one multimedia data object to a user indexed to said initial position;
updating said initial position to a subsequent position responsive to a position change command from a user via said user input; and
presenting at least one multimedia object to a user indexed to said subsequent position.

2. The method as set forth in claim 1 wherein said steps of presenting a multimedia data object comprise presenting a visual image of a mall or store interior.

3. The method as set forth in claim 2 wherein said steps of presenting a visual image of a mall or store interior further comprise the steps of:
providing a customer-selectable hot spot within said visual image; and
updating said customer's position responsive to selection of said hot spot.

4. The method as set forth in claim 1 wherein said steps of presenting multimedia data objects comprise presenting a sound clip representative of background sound within a mall or store interior.

5. A computer readable medium encoded with software for presenting information regarding products, suppliers and offerors to users in a virtual shopping mall on a communications terminal, said communications terminal having a user graphical display, a user input, and a memory, said software when executed by said communications terminal causing the communications terminal to perform the following actions:
storing in said memory a set of mall data objects, said mall data objects comprising a graphical map of a virtual shopping mall said map having a coordinate system associated with positions within the shopping mall, and a plurality of multimedia data objects indexed to said coordinate system;
providing a map of a virtual shopping mall, said map having a coordinate system associated with positions within the shopping mall;
assigning a customer an initial position having a set of coordinates within the shopping mall;
presenting at least one multimedia data object to a customer indexed to said initial position;
updating said initial position to a subsequent position responsive to a position change command from a user received via said user input; and
presenting at least one multimedia data object to a customer indexed to said subsequent position.

6. The computer readable medium as set forth in claim 5 wherein said software for performing the action of presenting a multimedia data object comprises software for presenting a visual image of a mall or store interior.

7. The computer readable medium as set forth in claim 6 wherein said software for presenting a visual image of a mall or store interior further comprises software for performing following actions:
providing a customer-selectable hot spot within said visual image; and
updating said customer's position responsive to selection of said hot spot.

8. The computer readable medium as set forth in claim 5 wherein said software for presenting a multimedia data object comprises software for presenting a sound clip representative of background sound within a mall or store interior.

9. A geographically-centered shopping mall browser for presenting information regarding products, suppliers and offerors to users in a virtual shopping mall using a communications terminal, said communications terminal having a user graphical display, a processor, a user input, and a memory, said shopping mall browser comprising:
a set of mall data objects disposed in said memory, said mall data objects comprising a graphical map of a virtual shopping mall, said map having a coordinate system associated with positions within the shopping mall, and a plurality of multimedia data objects indexed to said coordinate system;
a mall map displayer for showing on said communications terminal graphical display a geographical organization of a virtual mall contents;
a customer position initializer for assigning an initial user position having a set of coordinates within the virtual shopping mall;
a position tracker for updating said initial position to a subsequent position responsive to a position change command from a user via said user input; and
a multimedia data object presenter for presenting at least one multimedia object to a customer indexed to said initial position or said subsequent position.

10. The shopping mall browser as set forth in claim 9 wherein said multimedia data object presenter is adapted to present a visual image of a mall or store interior.

11. The shopping mall browser as set forth in claim 10 Wherein said multimedia data object presenter is further adapted to provide a customer-selectable hot spot within said visual image and to update a customer position responsive to selection of said hot spot.

12. The shopping mall browser as set forth in claim 9 wherein said multimedia object data presenter is adapted to present a sound clip representative of background sound within a mall or store interior.
